(19) United States
(12) Patent Application Publication
(10) Pub. No.: US 2014/0173606 A1
(43) Pub. Date: Jun. 19, 2014

(54) STREAMING PROCESSING OF SHORT READ ALIGNMENT ALGORITHMS

(71) Applicant: NVIDIA CORPORATION, Santa Clara, CA (US)

(72) Inventor: Jacopo PANTALEONI, Berlin (DE)

(73) Assignee: NVIDIA Corporation, Santa Clara, CA (US)

(21) Appl. No.: 13/719,796

(22) Filed: Dec. 19, 2012

(51) Int. Cl. G06F 9/46

(52) U.S. Cl. CPC G06F 9/46
USPC 718/102

(57) ABSTRACT

A technique for executing alignment algorithms on a SIMT processing environment is disclosed. An alignment algorithm having multiple stages is executed within the SIMT environment such that a different thread group executes each stage of the algorithm. Each thread group performs a different set of alignment operations related to a different stage of alignment algorithm for a group of short reads. In such a manner, the thread groups operate in unison to perform all the operations related to each stage of the alignment algorithm on every short read in the group of short reads.

### BACKGROUND OF THE INVENTION

1. Field of the Invention

The present invention generally relates to bioinformatics and, more specifically, to the streaming processing of short read alignment algorithms.

2. Description of the Related Art

In bioinformatics, aligning portions of DNA (referred to herein as “short reads”) with a reference genome provides valuable information for DNA analysis, such as identifying sequence variations and mutations. To generate such information, hundreds of thousands of short reads are aligned with a reference genome. Performing alignment operations in an efficient manner requires fast and accurate alignment algorithms, such as the Burrows Wheeler Aligner (BWA).

Typically, an instance of an alignment algorithm for aligning a particular short read with a reference genome is executed on a single thread within a processing unit. In a single thread, multiple data (SIMT) environment, however, such an execution mode is not efficient because the alignment algorithm does not execute uniformly across every thread. More specifically, when each thread in multiple threads executes an entire instance of the alignment algorithm, at given points in time, each thread may be executing different portions of the alignment algorithm as necessary. In a SIMT environment, having different threads executing different stages of an algorithm is extremely inefficient because the threads that are ahead must wait for the remaining threads to reach the same execution point. Requiring threads to wait for the remaining threads wastes processing cycles and slows down the overall execution of the various instances of the alignment algorithm.

Accordingly, what is needed in the art is an improved approach for executing short read alignment algorithms in a SIMT environment.

### SUMMARY OF THE INVENTION

One embodiment of the present invention sets forth a method for aligning a plurality of sets of base pairs with a reference genome. The method includes the steps of generating a plurality of root nodes wherein each root node in the plurality of root nodes is a root node of a search tree corresponding to each short read in the plurality of short reads, instantiating a plurality of thread groups within a processing unit for performing an alignment algorithm based on the tree representation in order to align the set of base pairs and the reference genome, wherein each thread group is responsible for executing a stage of the alignment algorithm; and transmitting the plurality of root nodes to the processing unit for processing across the plurality of thread groups.

One advantage of the techniques disclosed herein is that threads within a thread group executing a particular stage of the alignment algorithm perform the same alignment operations on data associated with different short reads. Having a distinct thread group perform each stage of the alignment algorithm reduces the number of wasted processing cycles because all the threads within a particular thread block perform the same operations and thus do not have to wait for other operations to complete.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention;

FIG. 2 is a block diagram of a parallel processing subsystem for the computer system of FIG. 1, according to one embodiment of the present invention;

FIG. 3A is a block diagram of the front end of FIG. 2, according to one embodiment of the present invention;

FIG. 3B is a block diagram of a general processing cluster within one of the parallel processing units of FIG. 2, according to one embodiment of the present invention;

FIG. 3C is a block diagram of a portion of the streaming multiprocessor of FIG. 3B, according to one embodiment of the present invention;

FIG. 4A illustrates a portion of a search tree for the short read GAATACA, according to one embodiment of the present invention;

FIG. 4B illustrates an alignment engine configured to execute a short read alignment algorithm, according to one embodiment of the present invention; and

FIG. 5 is a flow diagram of method steps for executing a short read alignment algorithm within an SPM, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

### System Overview

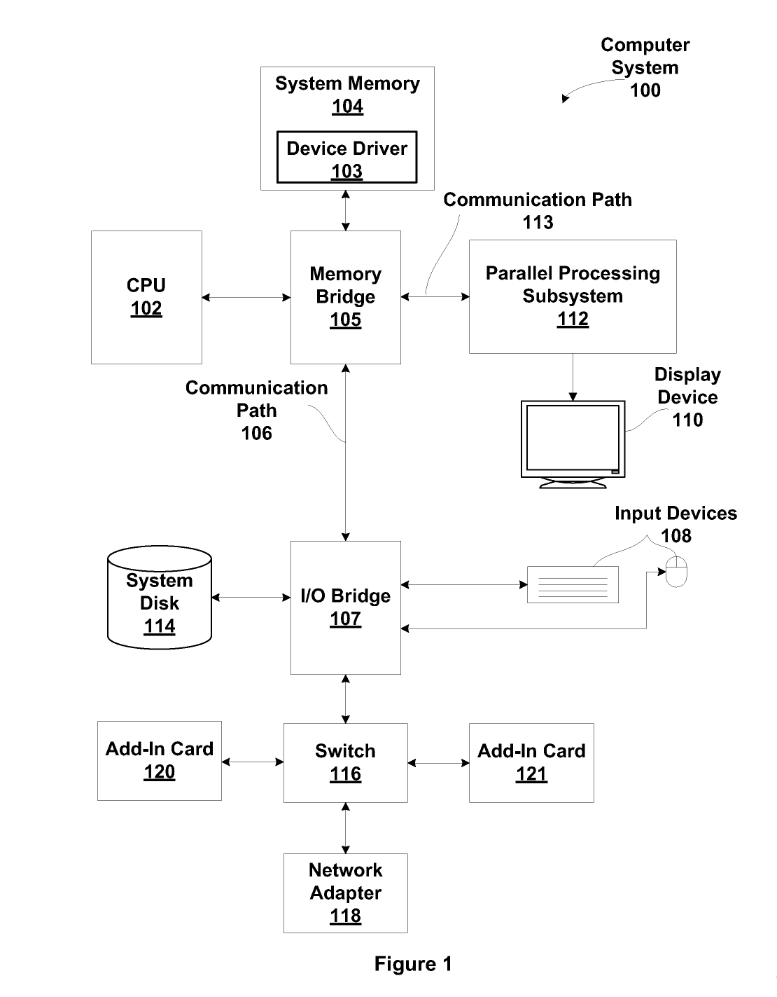

FIG. 1 is a block diagram illustrating a computer system 100 configured to implement one or more aspects of the present invention. Computer system 100 includes a central processing unit (CPU) 102 and a system memory 104 communicating via an interconnection path that may include a memory bridge 105. Memory bridge 105, which may be, e.g., a Northbridge chip, is connected via a bus or other communication path 106 (e.g., a HyperTransport link) to an I/O (input/output) bridge 107. I/O bridge 107, which may be, e.g., a Southbridge chip, receives user input from one or more user input devices 108 (e.g., keyboard, mouse) and forwards the input to CPU 102 via communication path 106 and memory bridge 105. A parallel processing subsystem 112 is coupled to memory bridge 105 via a bus or second communication path 113 (e.g., a Peripheral Component Interconnect (PCI) Express, Accelerated Graphics Port, or HyperTransport link); in one embodiment parallel processing subsystem 112 is a graphics subsystem that delivers pixels to a display device 110 that may be any conventional cathode ray tube, liquid crystal display, light-emitting diode display, or the like. A system disk 114 is also connected to I/O bridge 107 and may be configured to store content and applications and data for use by CPU 102 and parallel processing subsystem 112. System disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices.

A switch 116 provides connections between I/O bridge 107 and other components such as a network adapter 118 and various add-in cards 120 and 121. Other components (not explicitly shown), including universal serial bus (USB) or other port connections, compact disc (CD) drives, digital versatile disc (DVD) drives, film recording devices, and the like, may also be connected to 110 bridge 107. The various communication paths shown in FIG. 1, including the specifically named communication paths 106 and 113 may be implemented using any suitable protocols, such as PCI Express, AGP (Accelerated Graphics Port), HyperTransport, or any other bus or point-to-point communication protocol(s), and connections between different devices may use different protocols as is known in the art.

In one embodiment, the parallel processing subsystem 112 incorporates circuitry optimized for graphics and video processing, including, for example, video output circuitry, and constitutes a graphics processing unit (GPU). In another embodiment, the parallel processing subsystem 112 incorporates circuitry optimized for general purpose processing, while preserving the underlying computational architecture, described in greater detail herein. In yet another embodiment, the parallel processing subsystem 112 may be integrated with one or more other system elements in a single subsystem, such as joining the memory bridge 105, CPU 102, and I/O bridge 107 to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For instance, in some embodiments, system memory 104 is connected to CPU 102 directly rather than through a bridge, and other devices communicate with system memory 104 via memory bridge 105 and CPU 102. In other alternative topologies, parallel processing subsystem 112 is connected to 110 bridge 107 or directly to CPU 102, rather than to memory bridge 105. In still other embodiments, I/O bridge 107 and memory bridge 105 might be integrated into a single chip instead of existing as one or more discrete devices. Large embodiments may include two or more CPUs 102 and two or more parallel processing subsystems 112. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

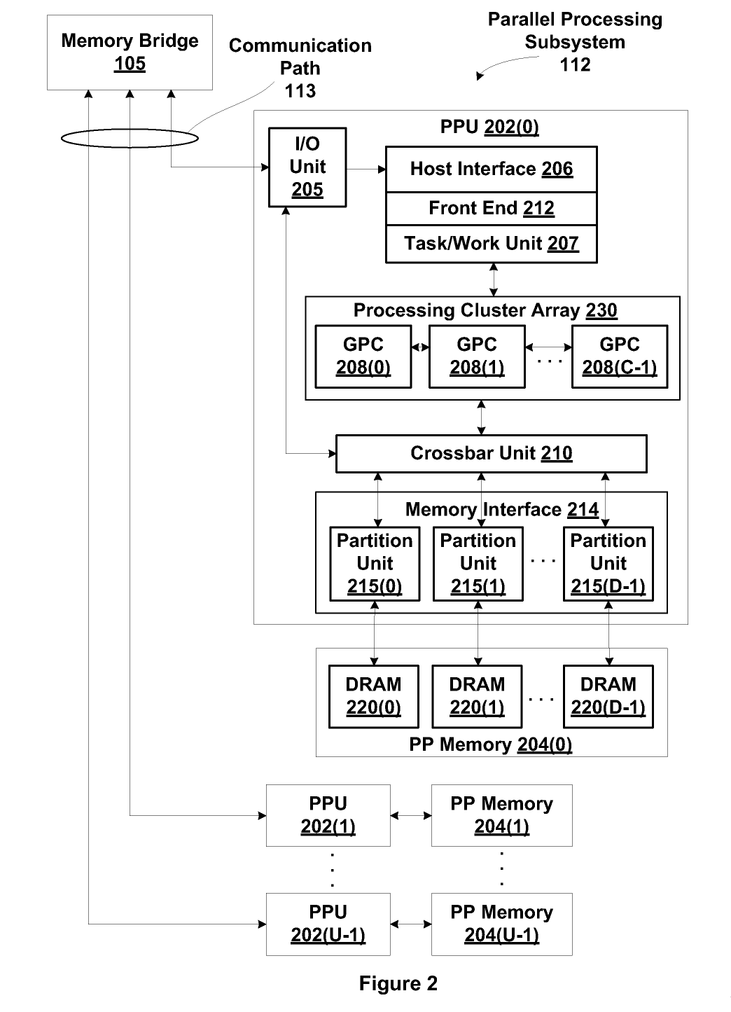

FIG. 2 illustrates a parallel processing subsystem 112, according to one embodiment of the present invention. As shown, parallel processing subsystem 112 includes one or more parallel processing units (PPUs) 202, each of which is coupled to a local parallel processing (PP) memory 204. In general, a parallel processing subsystem includes a number U of PPUs, where U≧1. (Herein, multiple instances of like objects are denoted with reference numbers identifying the object and parenthetical numbers identifying the instance where needed.) PPUs 202 and parallel processing memories 204 may be implemented using one or more integrated circuit devices, such as programmable processors, application specific integrated circuits (ASICs), or memory devices, or in any other technically feasible fashion.

Referring again 10 FIG. 1 as well as FIG. 2, ire some embodiments, some or all of PPUs 202 in parallel processing subsystem 112 are graphics processors with rendering pipelines that can be configured to perform various operations related to generating pixel data from graphics data supplied by CPU 102 and/or system memory 104 via memory bridge 105 and the second communication path 113, interacting with local parallel processing memory 204 (which can be used as graphics memory including, e.g., a conventional frame buffer) to store and update pixel data, delivering pixel data to display device 110, and the like. In some embodiments, parallel processing subsystem 112 may include one or more PPUs 202 that operate as graphics processors and one or more other PPUs 202 that are used for general-purpose computations. The PPUs may be identical or different, and each PPU may have a dedicated parallel processing memory device(s) or no dedicated parallel processing memory device(s). One or more PPUs 202 in parallel processing subsystem 112 may output data to display device 110 or each PPU 202 in parallel processing subsystem 112 may output data to one or more display devices 110.

In operation, CPU 102 is the master processor of computer system 100, controlling and coordinating operations of other system components. In particular, CPU 102 issues commands that control the operation of PPUs 202. In some embodiments, CPU 102 writes a stream of commands for each PPU 202 to a data structure (not explicitly shown in either FIG. 1 or FIG. 2) that may be located in system memory 104, parallel processing memory 204, or another storage location accessible to both CPU 102 and PPU 202. A pointer to each data structure is written to a pushbuffer to initiate processing of the stream of commands in the data structure. The PPU 202 reads command streams from one or more pushbuffers and then executes commands asynchronously relative to the operation of CPU 102. Execution priorities may be specified for each pushbuffer by an application program via the device driver 103 to control scheduling of the different pushbuffers.

Referring back now to FIG. 2 as well as FIG. 1, each PPU 202 includes an I/O (input/output) unit 205 that communicates with the rest of computer system 100 via communication path 113, which connects to memory bridge 105 (or, in one alternative embodiment, directly to CPU 102). The connection of PPU 202 to the rest of computer system 100 may also be varied. In some embodiments, parallel processing subsystem 112 is implemented as an add-in card that can be inserted into an expansion slot of computer system 100. In other embodiments, a PPU 202 can be integrated on a single chip with a bus bridge, such as memory bridge 105 or I/0 bridge 107. In still other embodiments, some or all elements of PPU 202 may be integrated on a single chip with CPU 102.

In one embodiment, communication path 113 is a PCI Express link, in which dedicated lanes are allocated to each PPU 202, as is known in the art. Other communication paths may also be used. An I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to parallel processing memory 204) may be directed to a memory crossbar unit 210. Host interface 206 reads each pushbuffer and outputs the command stream stored in the pushbuffer to a front end 212.

Each PPU 202 advantageously implements a highly parallel processing architecture. As shown in detail, PPU 202(0) includes a processing cluster array 230 that includes a number C of general processing clusters (GPCs) 208, where C≧1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary dependent on the workload arising for each type of program or computation.

GPCs 208 receive processing tasks to be executed from a work distribution unit within a task/work unit 207. The work distribution unit receives pointers to processing tasks that are encoded as task metadata (TMD) and stored in memory. The pointers to TMDs are included in the command stream that is stored as a pushbuffer and received by the front end unit 212 from the host interface 206. Processing tasks that may be encoded as TMDs include indices of data to be processed, as well as state parameters and commands defining how the data is to be processed (e.g., what program is to be executed). The task/work unit 207 receives tasks from the front end 212 and ensures that GPCs 208 are configured to a valid state before the processing specified by each one of the TMDs is initiated. A priority may be specified for each TMD that is used to schedule execution of the processing task. Processing tasks can also be received from the processing cluster array 230. Optionally, the TMD can include a parameter that controls whether the TMD is added to the head or the tail for a list of processing tasks (or list of pointers to the processing tasks), thereby providing another level of control over priority.

Memory interface 214 includes a number D of partition units 215 that are each directly coupled to a portion of parallel processing memory 204, where D≧1. As shown, the number of partition units 215 generally equals the number of dynamic random access memory (DRAM) 220. In other embodiments, the number of partition units 215 may not equal the number of memory devices. Persons of ordinary skill in the art will appreciate that DRAM 220 may be replaced with other suitable storage devices and can be of generally conventional design. A detailed description is therefore omitted. Render targets, such as frame buffers or texture maps may be stored across DRAMs 220, allowing partition units 215 to write portions of each render target in parallel to efficiently use the available bandwidth of parallel processing memory 204.

Any one of GPCs 208 may process data to be written to any of the DRAMs 220 within parallel processing memory 204. Crossbar unit 210 is configured to route the output of each GPC 208 to the input of any partition unit 215 or to another GPC 208 for further processing. GPCs 208 communicate with memory interface 214 through crossbar unit 210 to read from or write to various external memory devices. In one embodiment, crossbar unit 210 has a connection to memory interface 214 to communicate with I/O unit 205, as well as a connection to local parallel processing memory 204, thereby enabling the processing cores within the different GPCs 208 to communicate with system memory 104 or other memory that is not local to PPU 202. In the embodiment shown in FIG. 2, crossbar unit 210 is directly connected with I/O unit 205. Crossbar unit 210 may use virtual channels to separate traffic streams between the GPCs 208 and partition units 215.

Again, GPCs 208 can be programmed to execute processing tasks relating to a wide variety of applications, including but not limited to, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel shader programs), and so on. PPUs 202 may transfer data from system memory 104 and/or local parallel processing memories 204 into internal (on-chip) memory, process the data, and write result data back to system memory 104 and/or local parallel processing memories 204, where such data can be accessed by other system components, including CPU 102 or another parallel processing subsystem 112.

A PPU 202 may be provided with any amount of local parallel processing memory 204, including no local memory, and may use local memory and system memory in any combination. For instance, a PPU 202 can be a graphics processor in a unified memory architecture (UMA) embodiment. In such embodiments, little or no dedicated graphics (parallel processing) memory would be provided, and PPU 202 would use system memory exclusively or almost exclusively. In UMA embodiments, a PPU 202 may be integrated into a bridge chip or processor chip or provided as a discrete chip with a high-speed link (e.g., PCI Express) connecting the PPU 202 to system memory via a bridge chip or other communication means.

As noted above, any number of PPUs 202 can be included in a parallel processing subsystem 112. For instance, multiple PPUs 202 can be provided on a single add-in card, or multiple add-in cards can be connected to communication path 113, or one or more of PPUs 202 can be integrated into a bridge chip. PPUs 202 in a multi-PPU system may be identical to or different from one another. For instance, different PPUs 202 might have different numbers of processing cores, different amounts of local parallel processing memory, and so on. Where multiple PPUs 202 are present, those PPUs may be operated in parallel to process data at a higher throughput than is possible with a single PPU 202. Systems incorporating one or more PPUs 202 may be implemented in a variety of configurations and form factors, including desktop, laptop, or handheld personal computers, servers, workstations, game consoles, embedded systems, and the like.

### Multiple Concurrent Task Scheduling

Multiple processing tasks may be executed concurrently on the GPCs 208 and a processing task may generate one or more “child” processing tasks during execution. The task/work unit 207 receives the tasks and dynamically schedules the processing tasks and child processing tasks for execution by the GPCs 208.

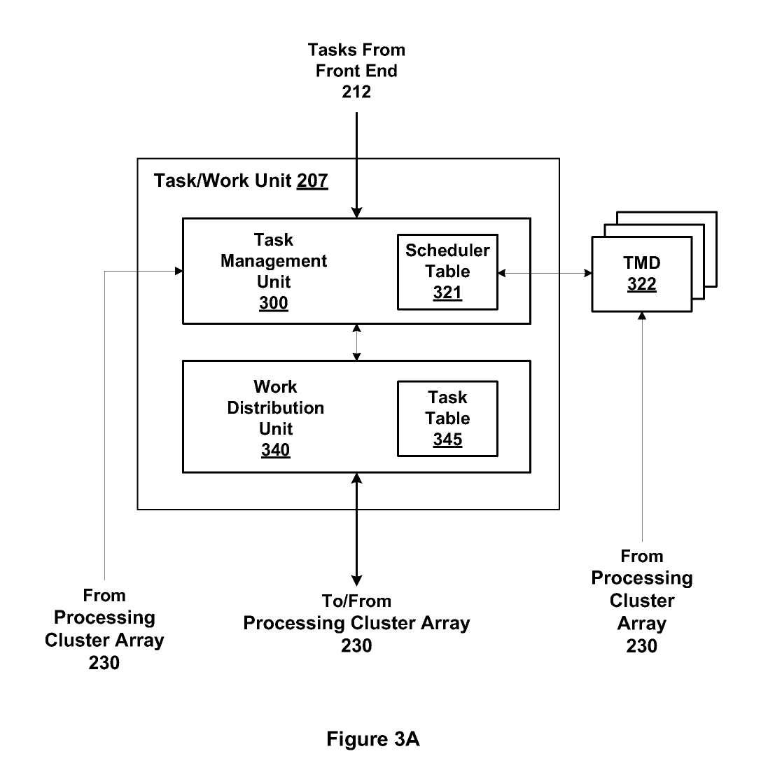

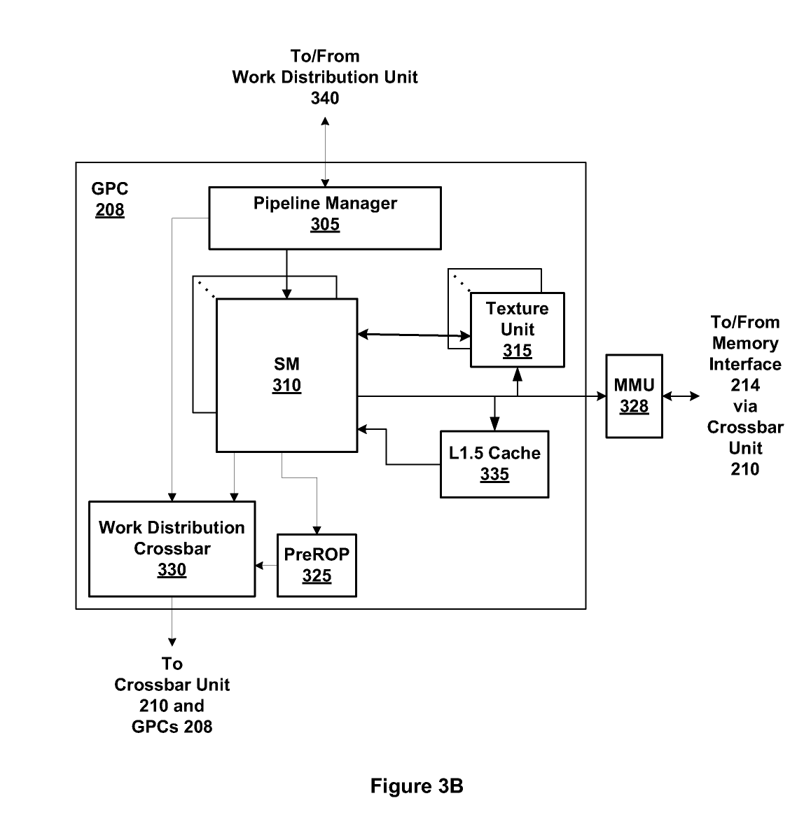

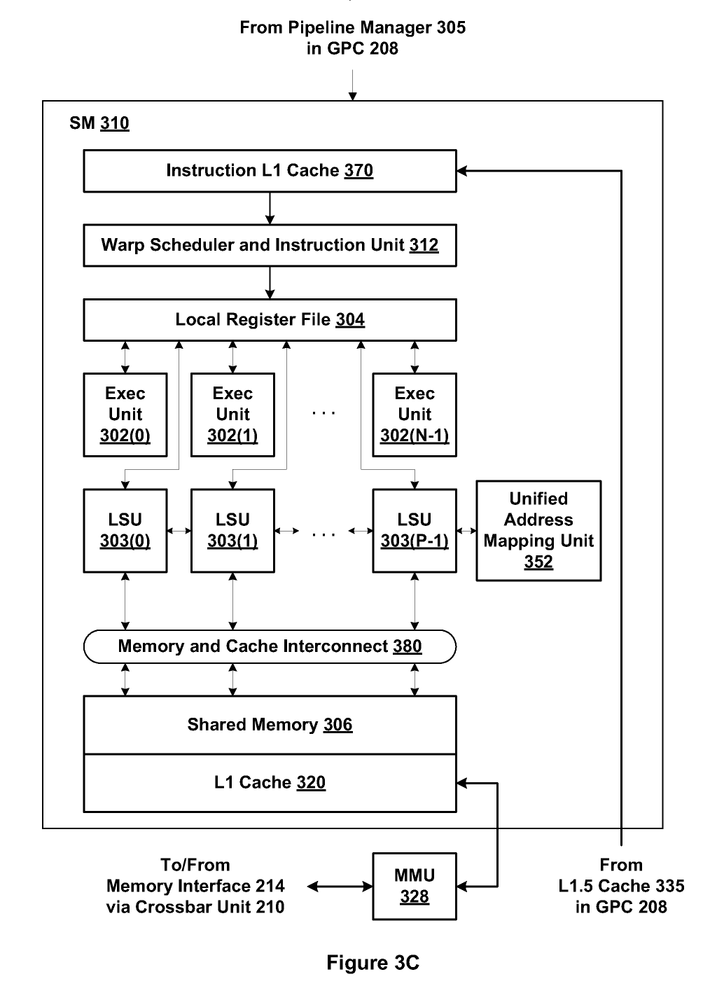

FIG. 3A is a block diagram of the task/work unit 207 of FIG. 2, according to one embodiment of the present invention. The task/work unit 207 includes a task management unit 300 and the work distribution unit 340. The task management unit 300 organizes tasks to be scheduled based on execution priority levels. For each priority level, the task management unit 300 stores a list of pointers to the TMDs 322 corresponding to the tasks in the scheduler table 321, where the list may be implemented as a linked list. The TMDs 322 may be stored in the PP memory 204 or system memory 104. The rate at which the task management unit 300 accepts tasks and stores the tasks in the scheduler table 321 is decoupled from the rate at which the task management unit 300 schedules tasks for execution. Therefore, the task management unit 300 may collect several tasks before scheduling the tasks. The collected tasks may then be scheduled, based on priority information or using other techniques, such as round-robin scheduling.

The work distribution unit 340 includes a task table 345 with slots that may each be occupied by the TMD 322 for a task that is being executed. The task management unit 300 may schedule tasks for execution when there is a free slot in the task table 345. When there is not a free slot, a higher priority task that does not occupy a slot may evict a lower priority task that does occupy a slot. When a task is evicted, the task is stopped, and if execution of the task is not complete, then a pointer to the task is added to a list of task pointers to be scheduled so that execution of the task will resume at a later time. When a child processing task is generated, during execution of a task, a pointer to the child task is added to the list of task pointers to be scheduled. A child task may be generated by a TMD 322 executing in the processing cluster array 230.

Unlike a task that is received by the task/work unit 207 from the front end 212, child tasks are received from the processing cluster array 230. Child tasks are not inserted into pushbuffers or transmitted to the front end. The CPU 102 is not notified when a child task is generated or data for the child task is stored in memory. Another difference between the tasks that are provided through pushbuffers and child tasks is that the tasks provided through the pushbuffers are defined by the application program whereas the child tasks are dynamically generated during execution of the tasks.

### Task Processing Overview

FIG. 3B is a block diagram of a GPC 208 within one of the PPUs 202 of FIG. 2, according to one embodiment of the present invention. Each GPC 208 may be configured to execute a large number of threads in parallel, where the term “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within each one of the GPCs 208. Unlike a SIMD execution regime, where all processing engines typically execute identical instructions, SIMT execution allows different threads to more readily follow divergent execution paths through a given thread program. Persons of ordinary skill in the art will understand that a SIMD processing regime represents a functional subset of a SIMT processing regime.

Operation of GPC 208 is advantageously controlled via a pipeline manager 305 that distributes processing tasks to streaming multiprocessors (SMs) 310. Pipeline manager 305 may also be configured to control a work distribution crossbar 330 by specifying destinations for processed data output by SMs 310.

In one embodiment, each GPC 208 includes a number M of SMs 310, where M≧1, each SM 310 configured to process one or more thread groups. Also, each SM 310 advantageously includes an identical set of functional execution units (e.g., execution units and load-store units—shown as Exec units 302 and LSUs 303 in FIG. 3C) that may be pipelined, allowing a new instruction to be issued before a previous instruction has finished, as is known in the art. Any combination of functional execution units may be provided. In one embodiment, the functional units support a variety of operations including integer and floating point arithmetic (e.g., addition and multiplication), comparison operations, Boolean operations (AND, OR, XOR), bit-shifting, and computation of various algebraic functions (e.g., planar interpolation, trigonometric, exponential, and logarithmic functions, etc.); and the same functional unit hardware can be leveraged to perform different operations.

The series of instructions transmitted to a particular GPC 208 constitutes a thread, as previously defined herein, and the collection of a certain number of concurrently executing threads across the parallel processing engines (not shown) within an SM 310 is referred to herein as a “warp” or “thread group.” As used herein, a “thread group” refers to a group of threads concurrently executing the same program on different input data, with one thread of the group being assigned to a different processing engine within an SM 310. A thread group may include fewer threads than the number of processing engines within the SM 310, in which case some processing engines will be idle during cycles when that thread group is being processed. A thread group may also include more threads than the number of processing engines within the SM 310, in which case processing will take place over consecutive clock cycles. Since each SM 310 can support up to G thread groups concurrently, it follows that up to G*M thread groups can be executing in GPC 208 at any given time.

Additionally, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group and is typically an integer multiple of the number of parallel processing engines within the SM 310, and m is the number of thread groups simultaneously active within the SM 310. The size of a CTA is generally determined by the programmer and the amount of hardware resources, such as memory or registers, available to the CTA.

Each SM 310 contains a level one (L1) cache (shown in FIG. 30) or uses space in a corresponding L1 cache outside of the SM 310 that is used to perform load and store operations. Each SM 310 also has access to level two (L2) caches that are shared among all GPCs 208 and may be used to transfer data between threads. Finally, SMs 310 also have access to off-chip “global” memory, which can include, e.g., parallel processing memory 204 and/or system memory 104. It is to be understood that any memory external to PPU 202 may be used as global memory. Additionally, a level one-point-five (L1.5) cache 335 may be included within the GPC 208, configured to receive and hold data fetched from memory via memory interface 214 requested by SM 310, including instructions, uniform data, and constant data, and provide the requested data to SM 310, Embodiments having multiple SMs 310 in GPC 208 beneficially share common instructions and data cached in L1.5 cache 335.

Each GPC 208 may include a memory management unit (MMU) 328 that is configured to map virtual addresses into physical addresses. In other embodiments, MMU(s) 328 may reside within the memory interface 214. The MMU 328 includes a set of page table entries (PTEs) used to map a virtual address to a physical address of a tile and optionally a cache line index. The MMU 328 may include address translation lookaside buffers (TLB) or caches which may reside within multiprocessor SM 310 or the L1 cache or GPC 208. The physical address is processed to distribute surface data access locality to allow efficient request interleaving among partition units 215. The cache line index may be used to determine whether or not a request for a cache line is a hit or miss.

In graphics and computing applications, a GPC 208 may be configured such that each SM 310 is coupled to a texture unit 315 for performing texture mapping operations, e.g., determining texture sample positions, reading texture data, and filtering the texture data. Texture data is read from an internal texture L1 cache (not shown) or in some embodiments from the L1 cache within SM 310 and is fetched from an L2 cache that is shared between all GPCs 208, parallel processing memory 204, or system memory 104, as needed. Each SM 310 outputs processed tasks to work distribution crossbar 330 in order to provide the processed task to another GPC 208 for further processing or to store the processed task in an L2 cache, parallel processing memory 204, or system memory 104 via crossbar unit 210. A preROP (pre-raster operations) 325 is configured to receive data from SM 310, direct data to ROP units within partition units 215, and perform optimizations for color blending, organize pixel color data, and perform address translations.

It will be appreciated that the core architecture described herein is illustrative and that variations and modifications are possible. Any number of processing units, e.g., SMs 310 or texture units 315, preROPs 325 may be included within a GPC 208. Further, as shown in FIG. 2, a PPU 202 may include any number of GPCs 208 that are advantageously functionally similar to one another so that execution behavior does not depend on which GPC 208 receives a particular processing task. Further, each GPC 208 advantageously operates independently of other GPCs 208 using separate and distinct processing units, L1 caches to execute tasks for one or more application programs.

Persons of ordinary skill in the art will understand that the architecture described in FIGS. 1, 2, 3A, and 3B in no way limits the scope of the present invention and that the techniques taught herein may be implemented on any properly configured processing unit, including, without limitation, one or more CPUs, one or more multi-core CPUs, one or more PPUs 202, one or more GPCs 208, one or more graphics or special purpose processing units, or the like, without departing the scope of the present invention.

In embodiments of the present invention, it is desirable to use PPU 202 or other processor(s) of a computing system to execute general-purpose computations using thread arrays. Each thread in the thread array is assigned a unique thread identifier (“thread ID”) that is accessible to the thread during the thread's execution. The thread ID, which can be defined as a one-dimensional or multi-dimensional numerical value controls various aspects of the thread's processing behavior. For instance, a thread ID may be used to determine which portion of the input data set a thread is to process and/or to determine which portion of an output data set a thread is to produce or write.

A sequence of per-thread instructions may include at least one instruction that defines a cooperative behavior between the representative thread and one or more other threads of the thread array. For example, the sequence of per-thread instructions night include an instruction to suspend execution of operations for the representative thread at a particular point in the sequence until such time as one or more of the other threads reach that particular point, an instruction for the representative thread to store data in a shared memory to which one or more of the other threads have access, an instruction for the representative thread to atomically read and update data stored in a shared memory to which one or more of the other threads have access based on their thread IDs, or the like. The CTA program can also include an instruction to compute an address in the shared memory from which data is to be read, with the address being a function of thread ID. By defining suitable functions and providing synchronization techniques, data can be written to a given location in shared memory by one thread of a CTA and read from that location by a different thread of the same CTA in a predictable manner. Consequently, any desired pattern of data sharing among threads can be supported, and any thread in a CTA can share data with any other thread in the same CTA. The extent, if any, of data sharing among threads of a CTA is determined by the CTA program; thus, it is to be understood that in a particular application that uses CTAs, the threads of a CTA might or might not actually share data with each other, depending on the CTA program, and the terms “CTA” and “thread array” are used synonymously herein.

FIG. 3C is a block diagram of the SM 310 of FIG. 3B, according to one embodiment of the present invention, The SM 310 includes an instruction L1 cache 370 that is configured to receive instructions and constants from memory via L1.5 cache 335. A warp scheduler and instruction unit 312 receives instructions and constants from the instruction L1 cache 370 and controls local register file 304 and SM 310 functional units according to the instructions and constants. The SM 310 functional units include N exec (execution or processing) units 302 and P lead-store units (LSU) 303.

SM 310 provides on-chip (internal) data storage with different levels of accessibility. Special registers (not shown) are readable but not writeable by LSU 303 and are used to store parameters defining each thread's “position.” In one embodiment, special registers include one register per thread (or per exec unit 302 within SM 310) that stores a thread 10, each thread ID register is accessible only by a respective one of the exec unit 302. Special registers may also include additional registers, readable by all threads that execute the same processing task represented by a TMD 322 (or by all LSUs 303) that store a CTA identifier, the CTA dimensions, the dimensions of a grid to which the CTA belongs (or queue position if the TMD 322 encodes a queue task instead of a grid task), and an identifier of the TMD 322 to which the CTA is assigned.

If the TMD 322 is a grid TMD, execution of the TMD 322 causes a fixed number of CTAs to be launched and executed to process the fixed amount of data stored in the queue 525. The number of CTAs is specified as the product of the grid width, height, and depth. The fixed amount of data may be stored in the TMD 322 or the TMD 322 may store a pointer to the data that will be processed by the CTAs. The TMD 322 also stores a starting address of the program that is executed by the CTAs.

If the TMD 322 is a queue TMD, then a queue feature of the TMD 322 is used, meaning that the amount of data to be processed is not necessarily fixed. Queue entries store data for processing by the CTAs assigned to the TMD 322. The queue entries may also represent a child task that is generated by another TMD 322 during execution of a thread, thereby providing nested parallelism. Typically, execution of the thread, or CTA that includes the thread, is suspended until execution of the child task completes. The queue may be stored in the TMD 322 or separately from the TMD 322, in which case the TMD 322 stores a queue pointer to the queue. Advantageously, data generated by the child task may be written to the queue while the TMD 322 representing the child task is executing. The queue may be implemented as a circular queue so that the total amount of data is not limited to the size of the queue.

CTAs that belong to a grid have implicit grid width, height, and depth parameters indicating the position of the respective CTA within the grid. Special registers are written during initialization in response to commands received via front end 212 from device driver 103 and do not change during execution of a processing task. The front end 212 schedules each processing task for execution. Each CTA is associated with a specific TMD 322 for concurrent execution of one or more tasks. Additionally, a single GPC 208 may execute multiple tasks concurrently.

A parameter memory (not shown) stores runtime parameters (constants) that can be read but not written by any thread within the same CTA (or any LSU 303). In one embodiment, device driver 103 provides parameters to the parameter memory before directing SM 310 to begin execution of a task that uses these parameters. Any thread within any CTA (or any exec unit 302 within SM 310) can access global memory through a memory interface 214. Portions of global memory may be stored in the L1 cache 320.

Local register file 304 is used by each thread as scratch space; each register is allocated for the exclusive use of one thread, and data in any of local register the 304 is accessible only to the thread to which the register is allocated. Local register The 304 can be implemented as a register file that is physically or logically divided into P lanes, each having some number of entries (where each entry might store, e.g., a 32-bit word). One lane is assigned to each of the N exec units 302 and P load-store units LSU 303, and corresponding entries in different lanes can be populated with data for different threads executing the same program to facilitate SIMM execution. Different portions of the lanes can be allocated to different ones of the G concurrent thread groups, so that a given entry in the local register file 304 is accessible only to a particular thread. In one embodiment, certain entries within the local register file 304 are reserved for storing thread identifiers, implementing one of the special registers. Additionally, a uniform L1 cache 375 stores uniform or constant values for each lane of the N exec units 302 and P load-store units LSU 303.

Shared memory 306 is accessible to threads within a single CTA; in other words, any location in shared memory 306 is accessible to any thread within the same CTA (or to any processing engine within SM 310). Shared memory 306 can be implemented as a shared register file or shared on-chip cache memory with an interconnect that allows any processing engine to read from or write to any location in the shared memory. In other embodiments, shared state space might map onto a per-CTA region of off-chip memory, and be cached in L1 cache 320. The parameter memory can be implemented as a designated section within the same shared register file or shared cache memory that implements shared memory 306, or as a separate shared register file or on-chip cache memory to which the LSUs 303 have read-only access. In one embodiment, the area that implements the parameter memory is also used to store the CTA ID and task ID, as well as CTA and grid dimensions or queue position, implementing portions of the special registers. Each LSU 303 in SM 310 is coupled to a unified address mapping unit 352 that converts an address provided for load and store instructions that are specified in a unified memory space into an address in each distinct memory space. Consequently, an instruction may be used to access any of the local, shared, or global memory spaces by specifying an address in the unified memory space.

The L1 cache 320 in each SM 310 can be used to cache private per-thread local data and also per-application global data. In some embodiments, the per-CTA shared data may be cached in the L1 cache 320. The LSUs 303 are coupled to the shared memory 306 and the L1 cache 320 via a memory and cache interconnect 380.

### Executing a Short Read Alignment Algorithm on a Streaming Multi-Processor

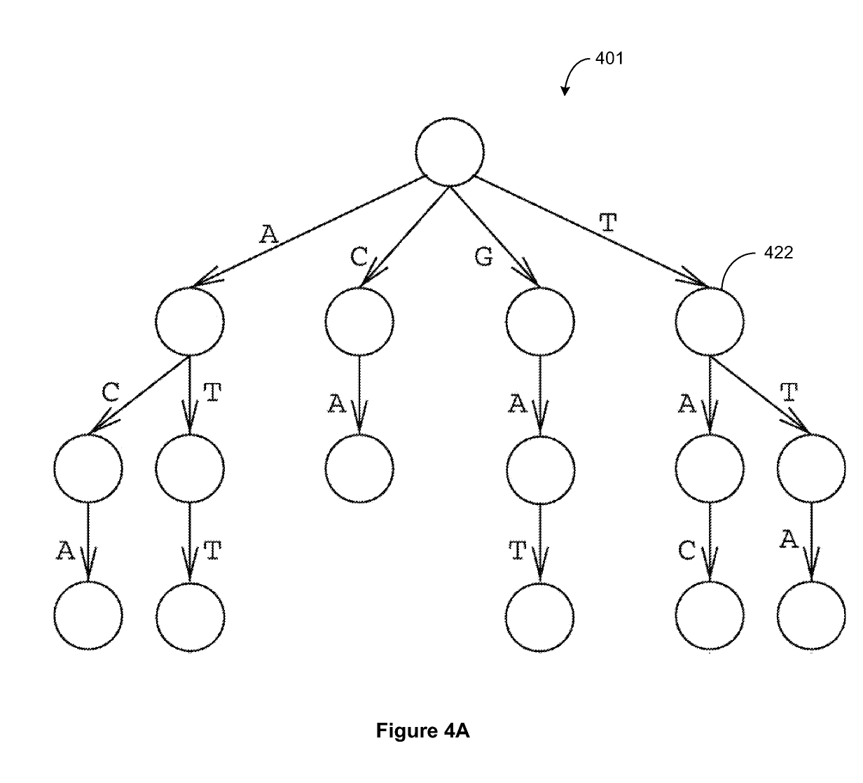

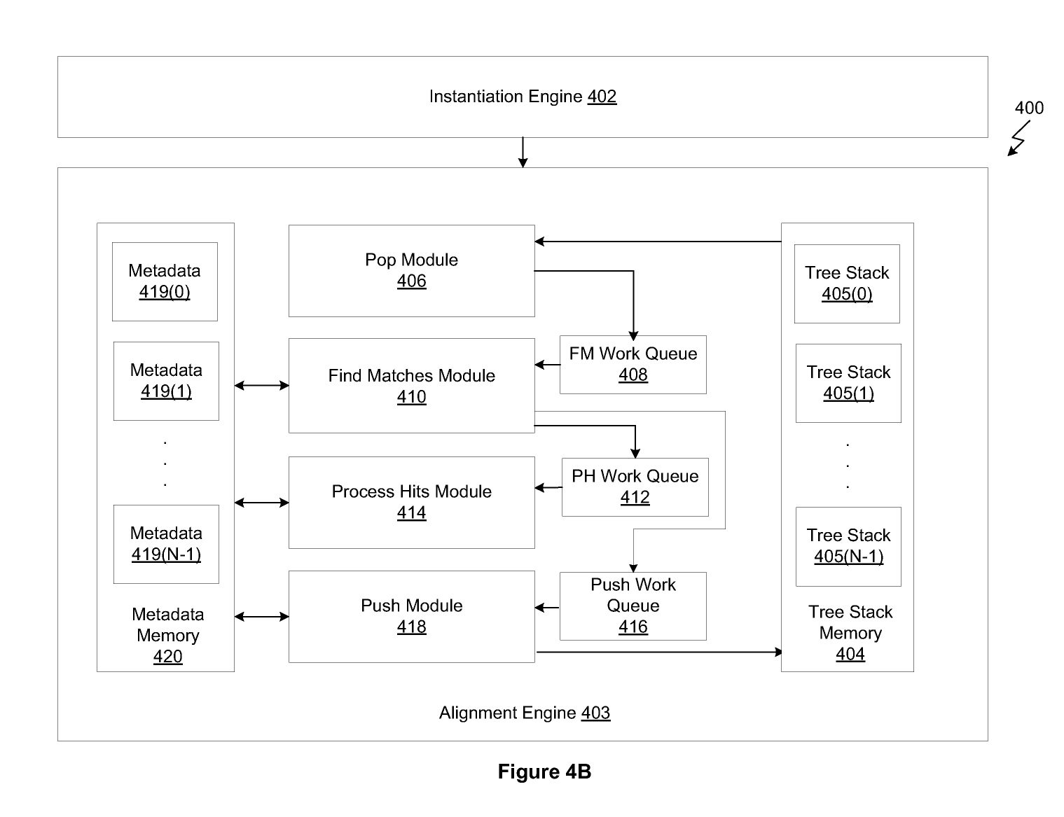

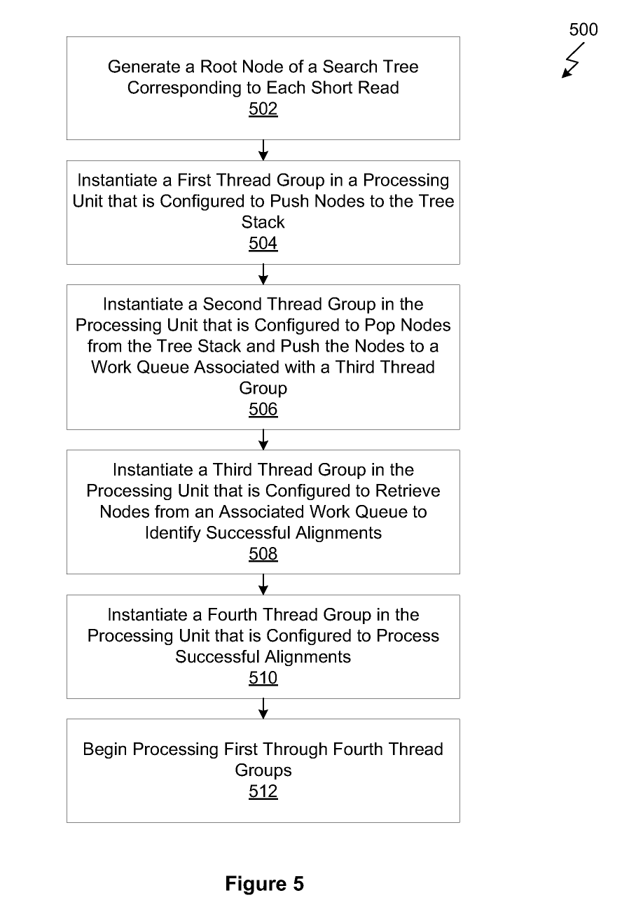

Given a reference genome and a set of base pairs (referred to herein as a “short read”), various alignment algorithms implement techniques for aligning the short read with portions of the reference genome that are similar or identical to the short read. The following discussion describes the details of the Burrows-Wheeler alignment algorithm for performing such short read alignment. FIGS. 4 and 5 then describe executing the Burrows-Wheeler alignment algorithm on at least one of the SMs 310 of FIG. 3C.

The Burrows-Wheeler aligner (BWA) is an algorithm for aligning a short read having N base pairs with a reference genome. In operation, a search tree having nine to the power of N nodes is considered based on the short read, where nine is the number of possible replacements of each base pair in the short read. Each replacement is either a mismatch (corresponding to the four possible A,C,T,G bases), an insertion or a gap. The root of the search tree corresponds to the last base pair of the short read.

In order to perform the alignment, the BWA traverses the search tree using a full-text substring index search (fm-index) to determine whether the suffix being formed as a result of the traversal exists in the reference genome. Additionally, each node in the search tree is associated with a quality score that is computed based on the number of mismatches, insertions and/or deletions. The BWA traverses the search tree by prioritizing the nodes based on the relative quality scores and pruning all branches having nodes with scores worse than the current best alignment found. The search tree is further pruned with the help of an auxiliary data structure that keeps track of the number of errors available at each position in the short read and is updated whenever a new alignment is found.

The search tree traversal technique implemented by the BWA for a particular short read is a loop that can be split in to four stages. In the first stage,the pop stage, BWA pops a node from a tree stack that initially includes the root node of the search tree corresponding to the short read. In addition, BWA initializes metadata associated with the short read, such as the auxiliary data structure and the current best alignment score. BWA executes the second stage, the find matches stage, only if the number of allowed differences specified by the metadata associated with the short read has exceeded a pre-determined threshold. If the number of allowed differences has exceeded the pre-determined threshold, then the find matches stage and the third stage are skipped and the traversal proceeds directly to the fourth stage.

In the second stage, the find matches stage, BWA performs an fm-index search to determine whether the short read aligns with the reference genome without errors, i.e. whether the short read exists as a suffix. If the short read aligns with a portion of the reference genome, then the portion (referred to herein as the “successful alignment”) is processed by the process hits stage discussed below. If the short read does not align, then BWA continues to the next iteration, going back to the pop stage.

In the third stage, the process hits stage, BWA processes the successful alignment identified in the second stage. More specifically, in the process hits stage, BWA computes a quality score associated with the successful alignment based on the number of mismatches, insertions and/or deletions. The quality score is stored in the metadata associated with the short read.

In the fourth stage, BWA retrieves the children of the node popped in the pop stage. BWA then examines each child node and computes a potential alignment score for the child node. If the potential score is lower than the current best score indicated by the metadata, then BWA pushes the child node to the tree stack.

FIG. 4A illustrates a portion of a search tree 401 for the short read GAATACA, according to one embodiment of the present invention. As shown, the search tree includes a series of nodes, such as node 422. Each node is associated with a particular suffix of the short read GAATACA.

FIG. 4B illustrates an alignment engine 403 configured to execute a short read alignment algorithm on SM 310, according to one embodiment of the present invention. The alignment engine 403 beneficially executes a short read alignment algorithm on many different short reads, in parallel. For each of the four stages listed above, a different thread block is instantiated. The different thread blocks communicate via work queues. Multiple thread blocks may be instantiated for execution of a short read alignment algorithm on multiple different short reads in the same genome, in parallel. For each parallel short read, four thread blocks are instantiated, each one corresponding to one of the four stages listed above.

As shown, a system 400 includes an instantiation engine 402 and the alignment engine 403. The alignment engine 403 includes a pop module 406, a find matches (FM) work queue 408, a find matches module 410, a process hits (PH) work queue 412, a process hits module 414, a push work queue 416 and a push module 418. The alignment engine 403 also includes metadata memory 420 and tree stack memory 404. In one embodiment, the instantiation engine 402 executes in the CPU 102 and the alignment engine 403 executes within the SM 310,

In operation, the instantiation engine 402 receives from a user via a user interface (not shown) a reference genome and a set of short reads that each need to be aligned with the reference genome. For each short read in the set of short reads, the instantiation engine 402 generates a different tree representation based on the base pairs included in the short read. Finally, the instantiation engine 402 instantiates four thread groups in an SM 310, each thread group to execute a different one of the pop module 406, the find matches module 410, the process hits module 414 and the push module 418. The instantiation engine 402 then transmits the reference genome and the tree representations to the alignment engine 403 for processing.

The alignment engine 403 receives the reference genome and the tree representations associated with the set of short reads from the instantiation engine 402. The alignment engine 403 creates a different tree stack 405 corresponding to each short read in the tree stack memory 404. Initially, the alignment engine 403 populates each tree stack 405 corresponding to a particular short read with the root node of the tree representation associated with that short read. For each short read in the set of short reads, the alignment engine 403 executes an instance of the BWA to perform the alignment operations discussed above. More specifically, the pop module 406 executes the pop stage described above for each of the BWA instances and the find matches module 410 executes the find matches stage described above for each of the BWA instances. Similarly, the process hits module 414 executes the process hits stage described above for each of the BWA instances and the push module 418 executes the push stage described above for each of the BWA instances.

The pop module 406 executing on a distinct thread group in an SM 310 pops nodes stored in the tree stacks 404 associated with the set of short reads. The pop module 406 pushes the nodes to the FM work queue 408 for further processing by the find matches module 410. The find matches module 410 retrieves nodes from the FM work queue 408 for processing.

For a node associated with a particular short read, the find matches module 410 analyzes the metadata 419 in metadata memory 420 corresponding to the short read to determine the number of differences already identified for the short read associated with the node. If the number of differences has not exceeded a pre-determined threshold, then the find matches module 410 pushes the node to the push work queue 416. If, however, the number of differences has exceeded the pre-determined threshold, then the find matches module 410 performs an fm-index search to determine whether the short read is aligned with the reference genome without errors, i.e. whether the short read exists as a suffix. If a portion of the genome is identified as aligned with the short read, the find matches module 410 transmits the portion,i.e., the alignment, to the PH work queue 412 for processing by the process hits module 414. If, however, the short read is not aligned with the reference genome, then the find matches module 410 discards the node.

The process hits module 414 retrieves alignments stored in the PH work queue 412 for further processing. For a particular alignment associated with a short read, the process hits module 414 computes a quality score associated with the alignment based on the number of mismatches, insertions and/or deletions. The quality score is stored in the metadata 419 corresponding to the particular short read for which the alignment was determined.

The push module. 418 retrieves nodes stored in the push work queue 416. For a particular node associated with a short read, the push module 418 retrieves the children of the node from the tree representation of the short read. The push module 418 then examines each child node and computes a potential alignment score for the child node. If the potential score is lower than the current best score indicated by the metadata 420, then the push module 418 pushes the child node to the tree stack.

FIG. 5 is a flow diagram of method steps for executing a short read alignment algorithm within an SM, according to one embodiment of the present invention. Although the method steps are described in conjunction with the system for FIG. 1-4, persons skilled in the art will understand that any system configured to perform the method steps, in any order, is within the scope of the invention.

As shown, a method 500 begins at step 502, where the instantiation engine 402 generates a root node of a search tree corresponding to the short read. At step 504, the instantiation engine 402 instantiates a first thread group within an SM 310 that is configured to push nodes corresponding to the search tree to a tree stack based on alignment scores associated with the nodes. At step 506, the instantiation engine 402 instantiates a second thread group within the SM 310 that is configured to pop nodes from the tree stack and push the nodes to a work queue associated with a third tread group.

At step 508, the instantiation engine 402 instantiates a third thread group within the SM 310 that is configured to retrieve nodes from the work queue associated with the third tread group. The third tread group processes the nodes to identify successful alignments between the short read corresponding to the nodes and a reference genome. At step 510, the instantiation engine 402 instantiates a fourth thread group within the SM 310 that is configured to process successful alignments identified by the third thread group.

At step 512, the instantiation engine 402 begins processing of the first through fourth thread groups. As discussed above, the first, second, third and fourth thread groups executing within the processing unit each perform a different stage of the short read alignment technique based on the search tree and a reference genome.

In sum, an alignment algorithm having multiple stages is executed within a SIMT environment such that a different thread group executes each stage of the algorithm. Each thread group performs a different set of alignment operations related to a different stage of alignment algorithm for a group of short reads. In operation, the output from a first thread group that performed a particular set of alignment operation on the short read is pushed to a work queue associated with a second thread group. When the second thread group has available processing cycles, the second thread group retrieves the output from the work queue for performing a different set of alignment operations on the output. In such a manner, the thread groups operate in unison to perform all the operations related to each stage of the alignment algorithm on every short read in the group of short reads.

One advantage of the techniques disclosed herein is that threads within a thread group executing a particular stage of the alignment algorithm perform the same alignment operations on data associated with different short reads. Having distinct thread group for each stage of the alignment algorithm reduces the number of wasted processing cycles as all the threads within a particular thread perform the same operations.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as compact disc read only memory (CD-ROM) disks readable by a CD-ROM drive, flash memory, read only memory (ROM) chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of embodiments of the present invention is set forth in the claims that follow.

We claim:

1. A computer-implemented method for aligning a plurality of short reads, each short read comprising a set of base pairs, with a reference genome, the method comprising:
generating a plurality of root nodes wherein each root node in the plurality of root nodes is a root node of a search tree corresponding to each short read in the plurality of short reads;
instantiating a plurality of thread groups within a processing unit for performing an alignment algorithm based on the tree representation in order to align the set of base pairs and the reference genome, wherein each thread group is responsible for executing a stage of the alignment algorithm; and
transmitting the plurality of root nodes to the processing unit for processing across the plurality of thread groups.

2. The method of claim 1, further comprising instantiating a plurality of processing stacks, each processing stack in the plurality of processing stacks associated with a short read in the plurality of short reads, wherein each processing stack in the plurality of processing stacks is configured to store nodes corresponding to tree representations, and populating each processing stack in the plurality of processing stacks with a root node in the plurality of rood nodes.

3. The method of claim 2, wherein instantiating the plurality of thread groups comprises instantiating a first thread group that is configured to retrieve one or more nodes from the stack and push the one or more nodes to a first work queue for processing.

4. The method of claim 3, wherein instantiating the plurality of thread groups comprises instantiating a second thread group that is configured to perform an alignment algorithm based on a first node retrieved from the first work queue, wherein the alignment algorithm is configured to determine whether a portion of reference genome aligns with the set of base pairs.

5. The method of claim 4, wherein the second thread group is further configured to terminate the alignment algorithm when the portion of the reference genome does not align with the set of base pairs.

6. The method of claim 4, wherein the second thread group is further configured to push the portion of the reference genome to a second work queue when the portion of the reference genome does align with the set of base pairs.

7. The method of claim 6, wherein instantiating the plurality of thread groups comprises instantiating a third thread group that is configured to compute a quality score associated with the portion of the reference genome, wherein the quality score indicates a similarity between the portion of the reference genome and the set of base pairs.

8. The method of claim 3, wherein instantiating the plurality of thread groups comprises instantiating a second thread group that is configured to push a first node retrieved from the first work queue to a second work queue for further processing.

9. The method of claim 8, wherein instantiating the plurality of thread groups comprises instantiating a fourth thread group that is configured to retrieve a set of child nodes associated with the first node from the tree representation and push at least one child node included in the set of child nodes onto the stack.

10. A computer-readable medium that stores instructions that, when executed by a processor, cause the processor to align a plurality of short reads, each shosrt read comprising a set of base pairs, with a reference genome, by performing the steps of:
generating a plurality of root nodes wherein each root node in the plurality of root nodes is a root node of a search tree corresponding to each short read in the plurality of short reads;
instantiating a plurality of thread groups within a processing unit for performing an alignment algorithm based on the tree representation in order to align the set of base pairs and the reference genome, wherein each thread group is responsible for executing a stage of the alignment algorithm; and
transmitting the plurality of root nodes to the processing unit for processing across the plurality of thread groups.

11. The computer-readable medium of claim 10, further comprising instantiating a plurality of processing stacks, each processing stack in the plurality of processing stacks associated with a short read in the plurality of short reads, wherein each processing stack in the plurality of processing stacks is configured to store nodes corresponding to tree representations, and populating each processing stack in the plurality of processing stacks with a root node in the plurality of rood nodes.

12. The computer-readable medium of claim 11, wherein instantiating the plurality of thread groups comprises instantiating a first thread group that is configured to retrieve one or more nodes from the stack and push the one or more nodes to a first work queue for processing.

13. The computer-readable medium of claim 12, wherein instantiating the plurality of thread groups comprises instantiating a second thread group that is configured to perform an alignment algorithm based on a first node retrieved from the first work queue, wherein the alignment algorithm is configured to determine whether a portion of the reference genome aligns with the set of base pairs.

14. The computer-readable medium of claim 13, wherein the second thread group is further configured to terminate the alignment algorithm when the portion of the reference genome does not align with the set of base pairs.

15. The computer-readable medium of claim 13, wherein the second thread group is further configured to push the portion of the reference genome to a second work queue when the portion of the reference genome does align with the set of base pairs.

16. The computer-readable medium of claim 15, wherein instantiating the plurality of thread groups comprises instantiating a third thread group that is configured to compute a quality score associated with the portion of the reference genome, wherein the quality score indicates a similarity between the portion of the reference genome and the set of base pairs.

17. The computer-readable medium of claim 12, wherein instantiating the plurality of thread groups comprises instantiating a second thread group that is configured to push a first node retrieved from the first work queue to a second work queue for further processing.

18. The computer-readable medium of claim 17, wherein instantiating the plurality of thread groups comprises instantiating a fourth thread group that is configured to retrieve a set of child nodes associated with the first node from the tree representation and push at least one child node included in the set of child nodes onto the stack.

19. A computer system, comprising:
a memory;
a processing unit executing multiple thread groups; and
an instantiation engine configured to:
generate a plurality of root nodes wherein each root node in the plurality of root nodes is a root node of a search tree corresponding to each short read in the plurality of short reads;
instantiate a plurality of thread groups within a processing unit for performing an alignment algorithm based on the tree representation in order to align the set of base pairs and the reference genome, wherein each thread group is responsible for executing a stage of the alignment algorithm; and
transmit the plurality of root nodes to the processing unit for processing across the plurality of thread groups.

20. The computer system of claim 19, wherein the instantiation engine is further configured to instantiate a plurality of processing stacks, each processing stack in the plurality of processing stacks associated with a short read in the plurality of short reads, wherein each processing stack in the plurality of processing stacks is configured to store nodes corresponding to tree representations, and populate each processing stack in the plurality of processing stacks with a root node in the plurality of rood nodes.
